(19) United States
(12) Patent Application Publication
(10) Pub. No.: US 2013/0090416 A1
(43) Pub. Date: Apr. 11, 2013

(54) HIGH TEMPERATURE POLYMER ALLOY CONTAINING STABILIZERS

(71) Applicants: Xinyu Zhao, Cincinnati, OH (US); Ke Feng, Cincinnati, OH (US)

(72) Inventors: Xinyu Zhao, Cincinnati, OH (US); Ke Feng, Cincinnati, OH (US)

(21) Appl. No.: 13/643,393

(22) PCT Filed: May 21, 2010
(86) PCT No.: PCT/US10/35779

§ 371 Date: Dec. 14, 2012

(51) Int. Cl. C08L 81/04

(52) U.S. Cl. CPC C08L 81/04
USPC 524/127; 524/154; 524/128; 264/328.12

(57) ABSTRACT

The present disclosure is generally directed to a resin composition containing a mixture of high temperature polymers and at least one stabilizer. The stabilizer serves to prevent the polymers from adversely interfering with each other during melt processing. In one embodiment, the high temperature polymers present in the composition may comprise a mixture of an aromatic polyester polymer and a polyarylene sulfide polymer. The stabilizer comprises a phosphite stabilizer. The composition produces molded articles having better thermal stability and reduced mold deposits.

### BACKGROUND

Various different high temperature engineering plastics exist that can be used to form different parts and articles. Such polymers include, for instance, polyarylene sulfide polymers and aromatic polyester polymers, which are also referred to as liquid crystal polymers. These types of polymers are strong, have excellent chemical resistance, have high rigidity, and have good resistance to heat such that they can be used in high temperature applications. The above polymers are also thermoplastic in nature allowing them to be used in various molding processes, such as injection molding, for forming parts having either simple or very complex shapes.

The particular thermoplastic polymer selected for a particular application generally depends upon the characteristics of the polymer. Each of the high temperature engineering plastics, for instance, has their own advantages and disadvantages. For example, polyarylene sulfide polymers have excellent flame resistance, chemical resistance, and high weld line strength. Polyarylene sulfide polymers, however, has some limitation in molding process, such as it tends to generate flash during molding.

Liquid crystal polymers, such as aromatic polyester polymers, on the other hand, have greater flowability and processability in comparison to polyarylene sulfide polymers. Liquid crystal polymers, however, typically exhibit mechanical properties in one direction that are different to the mechanical properties of the polymer exhibited in a perpendicular direction. As a result, liquid crystal polymers have relatively lower weld line strength than polyarylene sulfide.

In view of the above, those skilled in the art have attempted to combine polyarylene sulfide polymers with liquid crystal polymers in certain applications. A polymer blend containing a polyarylene sulfide polymer and an aromatic polyester polymer, for instance, is disclosed in U.S. Pat. No. 6,010,760, which is incorporated herein by reference. Unfortunately, however, liquid crystal polymers are not entirely compatible with polyarylene sulfide polymers. In particular, thermal degradation of the polymers can occur when the polymers are heated together during a molding process. The thermal instability can produce deposits on the mold surface. When excessive deposits accumulate on the mold surface, it may stick to the surface of the part such as connectors for electronic applications, where it is very sensitive to any contaminations. In this case, the continuous molding process has to be stopped and the mold has to be cleaned before restarting. This may result in defect parts with contamination or significant lose of productivity.

In view of the above, a need currently exists for a resin composition containing a polyarylene sulfide polymer combined with a polyester aromatic polymer that prevents or minimizes thermal degradation when the mixture is heated to temperatures sufficient for the polymers to flow.

### SUMMARY

The present disclosure is generally directed to a polymer alloy composition that is particularly well suited for forming molded products, such as injection molded articles. The polymer alloy composition generally contains a mixture of high temperature thermoplastic polymers in addition to one or more stabilizers. The one or more stabilizers prevent the polymers from thermally degrading when the polymers are heated together to a temperature sufficient for the polymers to flow. By preventing degradation, in one embodiment, mold deposit formation can be minimized so that defect parts with contamination and downtime for cleanup can be minimized. In this manner, the two high temperature polymers can be blended together so that their mechanical properties can be synergistically combined in the resulting product without adverse consequences.

In one embodiment, for instance, the present disclosure is directed to a resin composition that contains a polymer mixture of an aromatic polyester polymer and a polyarylene sulfide polymer. The aromatic polyester polymer and the polyarylene sulfide polymer can be present in the polymer mixture at a weight ratio from about 5:1 to about 1:5, such as from about 1:2 to about 1:3. In addition, the aromatic polyester polymer and the polyarylene sulfide polymer may be present in the polymer mixture such that the polymers have a viscosity ratio at 350° C. of from about 1:10 to about 3:1, such as from about 1.5:1 to about 1:1.5.

In accordance with the present disclosure, the resin composition further contains at least one stabilizer. The stabilizer comprises an organic phosphite. More particularly, the organic phosphite may comprise a monophosphite or a diphosphite. Diphosphites that are particularly well suited for use in the present disclosure include diphosphites that do not absorb moisture, such as certain pentaerythritol diphosphites. In one embodiment, a diphosphite is selected that has a relatively high spiro isomer content. For instance, the diphosphite can have a spiro isomer content of greater than about 90%, such as greater than 95%, such as even greater than 98%.

An example of a monophosphite that might be used in accordance with the present disclosure is tris(2,4-di-tert-butylphenyl)phosphite. Diphosphites that may be used include bis(2,4-dicumylphenyl)pentaerythritol diphosphite or distearyl pentaerythritol diphosphite. The above phosphites may be used alone or in combination.

In addition to a first stabilizer as described above, the composition may also optionally contain a second stabilizer. The second stabilizer, for instance, may comprise a phosphate or may comprise a random ethylene-acrylic ester interpolymer containing maleic anhydride or glycidyl methacrylate.

Phosphates that may be used include, for instance, organic polyphosphates. In one embodiment, the phosphate may have the following formula:

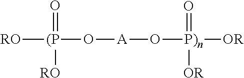

wherein r is either an unsubstituted or a substituted aryl, A is a bridging group containing an alkylene group, one arylene ring, two arylene rings either joined directly to each other or by an alkylene bridging group and n ranges from 1 to about 10.

In one particular embodiment, the organic polyphosphate may comprise resorcinol bis(di-xylyl phosphate).

The stabilizers can be present in the composition in any suitable concentration capable of reducing degradation of the polymer mixture. In one particular embodiment, for instance, the phosphite stabilizer may be present in the composition in an amount from about 0.05% to about 3% by weight, such as from about 0.1% to about 1% by weight.

The polyarylene sulfide present in the resin composition can vary depending on the particular application. In one embodiment, for instance, the polyarylene sulfide may comprise a polyphenylene sulfide. In one particular embodiment, the polyarylene sulfide may have a melt viscosity of less than about 80 Pa·s, such as from about 40 Pa·s to about 70 Pa·s.

As used herein, melt viscosity for a polyarylene sulfide is determined in accordance with ASTM1238-70 at 316° C. and a shear rate of 1200 s⁻¹. Melt viscosity for a liquid crystal polymer is determined in accordance with ASTM1238-70 at 350° C. and a shear rate of 1000 s⁻¹. When viscosity is referred to, the above conditions for the melt viscosity of a liquid crystal polymer is used to measure viscosity for polyarylene sulfide and liquid crystal polymer.

The aromatic polyester polymer present in the resin composition can also vary depending upon the particular application. In one embodiment, the particular aromatic polyester polymer selected has a melting point of greater than about 250° C., such as from about 250° C. to about 400° C. In one particular embodiment, the aromatic polyester polymer may have a melting point of from about 320° C. to about 350° C.

In addition to the polymer mixture and the phosphite stabilizer, the resin composition may contain various other ingredients. For instance, in one embodiment, a lubricant may be present within the composition. The lubricant may comprise, for instance, a polytetrafluoroethylene polymer, a high density polyethylene polymer, an ultra high molecular weight polyethylene polymer, or pentaerythritol stearate.

In many embodiments, reinforcing materials may be present in the resin composition. For instance, in one embodiment, the composition may contain reinforcing fibers, such as glass fibers or carbon fibers. The fibers may be present in an amount from about 10% to about 70% by weight. As an alternative to reinforcing fibers or in combination with reinforcing fibers, the composition may also contain various mineral fillers.

In one embodiment, all of the components of the composition can be precompounded together prior to forming a product or article. For instance, the resin composition may be in the form of pellets. As described above, the resin composition is particularly well suited for use in molding applications. For instance, in one embodiment, the present disclosure is directed to an injection molded article made from the composition.

Of particular advantage, when the polymer alloy composition of the present disclosure is used to form molded parts, the composition produces virtually no mold deposits. For instance, in one embodiment, the composition can be used in a continuous process for injection molding. After more than about two hours of molding, such as even after more than four hours of molding, the alloy composition produces virtually no mold deposits. For instance, the surface area of the mold may contain less than 10% mold deposits, such as less than 5% mold deposits, such as even less than 2% mold deposits.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIGS. 1 through 5 are graphical representations and pictorial representations of some of the results obtained in the Examples below.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a resin composition containing a polymer alloy and to various articles and products that can be made from the composition. More particularly, the resin composition generally contains a mixture of high temperature thermoplastic polymers combined with at least one phosphite stabilizer. The phosphite stabilizer has been found to prevent degradation of the polymer mixture when the mixture is subjected to heat. In particular, the stabilizer prevents one of the polymers from adversely interacting with the other polymer. Ultimately, a resin composition is produced that, when molded into articles, produces products having a minimal amount of defects with minimum interruption of continuous molding process.

In one embodiment, the resin composition contains a mixture of a polyarylene sulfide polymer and an aromatic polyester polymer combined with the phosphite stabilizer. The stabilizer generally comprises an organic phosphite. In one embodiment, for instance, the phosphite stabilizer may comprise a monophosphite. In an alternative embodiment, the phosphite stabilizer may comprise a diphosphite wherein the diphosphite has a molecular configuration that inhibits the absorption of moisture and/or has a relatively high spiro isomer content. For instance, in one embodiment, a diphosphite may be selected that has a spiro isomer content of greater than 90%, such as greater than 95%, such as greater than 98%.

The above phosphites may be used alone or in combination. The composition can further contain various other additives, such as other stabilizers, lubricants, reinforcing fibers, mineral fillers, and the like.

The polyarylene sulfide resin that may be used in the composition of the present disclosure can vary depending upon particular application and the desired results. Polyarylene sulfide resins that may be used are comprised of repeating units represented by the formula —(—Ar—S—)—, wherein Ar is an arylene group.

Examples of arylene groups that can be present in the polyarylene sulfide resin include p-phenylene, m-phenylene, o-phenylene and substituted phenylene groups (wherein the substituent is an alkyl group preferably having 1 to 5 carbon atoms or a phenyl group), p,p′-diphenylene sulfone, p,p′-biphenylene, p,p′-diphenylene ether, p,p′-diphenylenecarbonyl and naphthalene groups.

Polyarylene sulfides that may be used, in one embodiment, include polyarylene thioethers containing repeat units of the formula:

—[(Ar¹)ₙ—X]ₘ—[(Ar²)ᵢ—Y]ⱼ—(Ar³)ₖ—Z]ₗ—[(Ar⁴)ₒ—W]ₚ—

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Arylene units include phenylene, biphenylene, naphthylene, anthracene and phenanthrene. The polyarylene sulfide can include at least 30 mole percent, particularly at least 50 mole percent and more particularly at least 70 mole percent arylene sulfide (—S—) units. The polyarylene sulfide polymer can include at least 85 mole percent sulfide linkages attached directly to two aromatic rings.

In one embodiment, the polyarylene sulfide polymer is polyphenylene sulfide (PPS), defined herein as containing the phenylene sulfide structure —(C₆H₄—S)ₙ— (wherein n is an integer of 1 or more) as a component thereof.

Synthesis techniques that can be used in making polyphenylene sulfide resins that are suitable for utilization in the practice of this invention are described in U.S. Pat. No. 4,814,430, U.S. Pat. No. 4,889,893, U.S. Pat. No. 5,380,783, and U.S. Pat. No. 5,840,830, the teachings of which are incorporated herein by reference in their entirety.

When the resin composition of the present disclosure is intended to be melt processed, a polyarylene sulfide polymer can be selected that has a molecular weight and melt viscosity range that provides good flowability when the polymer is heated. For instance, in one embodiment, the polyarylene sulfide polymer can have a melt viscosity of generally less than about 100 Pa·s. As used herein, melt viscosity is determined in accordance with ASTM1238-70 at 316° C.

In certain embodiments, for instance, the melt viscosity may be less than about 70 Pa·s, such as from about 10 Pa·s to about 70 Pa·s. In one particular embodiment, the melt viscosity of the polyarylene sulfide polymer may be from about 45 Pa·s to about 65 Pa·s.

In general, lower melt viscosities relate to polymers that are easy to process. For polyarylene sulfide polymers, however, lower melt viscosity polymers generally have a greater chlorine content. In some applications, for instance, it is desirable to have a low halogen or chlorine content. Thus, a balance must be struck between selecting a polymer having an appropriate melt viscosity while also selecting a polymer that has a low chlorine content. In some applications, for instance, it is desirable to select a polyarylene sulfide polymer that has a chlorine content of less than about 2000 parts per million to generate a compound with chlorine content of less than 900 parts per million. Such polymers will generally have a melt flow viscosity of at least greater than about 40 Pa·s.

Polyarylene sulfide polymers that may be used in the present disclosure are available from numerous commercial sources. In one embodiment, for instance, polymers can be purchased from Ticona LLC and/or the Celanese Corporation under the trade name FORTRON. Particular grades well suited for use in the present disclosure include grades 0202, 0203, 0205, 0214, 0309, and mixtures thereof.

In one embodiment, a polyarylene sulfide polymer having a relatively high melt viscosity can be combined with a polyarylene sulfide polymer having a relatively low melt viscosity for producing a PPS polymer having the desired characteristics.

As described above, the resin composition of the present disclosure includes a polyarylene sulfide polymer combined with a wholly aromatic polymer, such as an aromatic polyester, which are typically referred to in the art as liquid crystal polymers. The aromatic polyester, for instance, may comprise a polyester anisotropic polymer formed from an aromatic hydroxycarboxylic acid, an aromatic dial, and an aromatic diacid. As used herein, an aromatic polyester also includes aromatic polyester amides.

In one embodiment, the aromatic polymer can be produced as described in U.S. Pat. No. 5,798,432 which is incorporated herein by reference. For example, the monomers are polymerized by a melt acidolysis polymerization process, in which non-acetylated monomers are heated in the presence of acetic anhydride. Alternatively, the monomers can be acetylated in a first step, and the acetylated monomers can then be polymerized by a melt acidolysis process in the molten state in a second step. Reaction of monomers in the presence of acetic anhydride is preferred.

In either case, the monomers are heated with stirring to a sufficiently high temperature that the acetylated phenol or amine groups react with the carboxylic acid groups to form amide or ester linkages, with the formation of by-product acetic acid. The heating and stirring are continued for a long enough time and at a high enough temperature that a polymer forms that has an inherent viscosity (I.V.) of at least about 2 dl/g, preferably at least about 3 dl/g, and most preferably at least about 5 dl/g, with the I.V. being measured at 25° C. as a 0.1% solution (wt/vol) of polymer in a mixture of equal volumes of pentafluorophenol and hexafluoroisopropanol. Typically, the polymerization is completed at a temperature high enough that the polymer is in the molten state at a temperature in the range of about 280° C. to about 380° C., preferably in the range of about 320° C. to about 380° C. The polymer is normally heated under vacuum in the molten state for up to about one hour, with the time being dependent on such variables as the temperature, the vacuum, and the stirring speed.

In one particular embodiment, for instance, the polymer is produced via polycondensation (with elimination of acetic acid) from p-hydroxybenzoic acid, an aromatic dihydroxy compound (such as 4,4′-dihydroxybiphenyl and hydroquinone), and an aromatic dicarboxylic acid (such as 2,6-naphthalenedicarboxylic acid, terephthalic acid, and isophthalic acid), with their phenolic hydroxyl groups acylated by reaction with acetic anhydride.

Alternatively the resins can be made by polycondensation (with elimination of acetic acid) from p-acetoxybenzoic acid, a diacylated aromatic dihydroxy compound (such as 4,4′-diacetoxybiphenyl and diacetoxybenzene), and an aromatic dicarboxylic acid (such as 2,6-naphthalenedicarboxylic acid, terephthalic acid, and isophthalic acid).

Another alternative resin preparation method is polycondensation (with elimination of phenol) from a phenyl ester of p-hydroxybenzoic acid and a diphenyl ester of an aromatic dihydroxy compound (such as 4,4′-dihydroxybiphenyl and hydroquinone) and an aromatic dicarboxylic acid (such as 2,6-naphthalenedicarboxylic acid, terephthalic acid, and isophthalic acid).

In still another embodiment, the resin is prepared by polycondensation (with elimination of phenol) from diphenyl esters and aromatic dihydroxy compounds. The diphenyl esters can be formed from p-hydroxy-benzoic acid and an aromatic dicarboxylic acid (such as 2,6-naphthalenedicarboxylic acid, terephthalic acid, and isophthalic acid) by reaction with diphenyl carbonate in a prescribed amount. The aromatic dihydroxy compounds can include 4,4′-dihydroxybiphenyl and hydroquinone.

The above-mentioned polycondensation reactions can proceed in the absence of a catalyst; however, they may be catalyzed by a metal compound (such as stannous acetate, tetrabutyl titanium, preferably potassium acetate, sodium acetate, and antimony trioxide) or metallic magnesium or a combination thereof. In one embodiment, the use of catalysts is eliminated or minimized in order to prevent the resulting polymer from blistering. For example, in one embodiment, the polymer resin can contain less than about 500 ppm of metal catalyst, such as less than about 200 ppm, such as less than about 100 ppm, such as less than about 50 ppm, such as less than about 20 ppm, such as less than about 10 ppm of catalyst.

In one embodiment, the polymer resin can be formed in the presence of one or more end-capping agents. End-capping agents, for instance, can be used to control the molecular weight, melting point, and/or viscosity of the polymer. The end-capping agent, for instance, can be present in the resulting polymer in an amount less than about 1 mole % by weight, such as in an amount less than about 0.5 mole %. In one embodiment, for instance, the end capping agent may comprise terephthalic acid in an amount less than about 0.2 mole %.

Improvements in the control of the resulting properties of the polymer may also be realized in one embodiment by forming the polymer using slight molar excesses of a diacid, a diol, or both.

In one embodiment, the wholly aromatic polymer resin incorporated into the composition of the present disclosure is selected from a group of polymers of P1 to P8, wherein each polymer contains at least two of the following repeating units i) through viii):

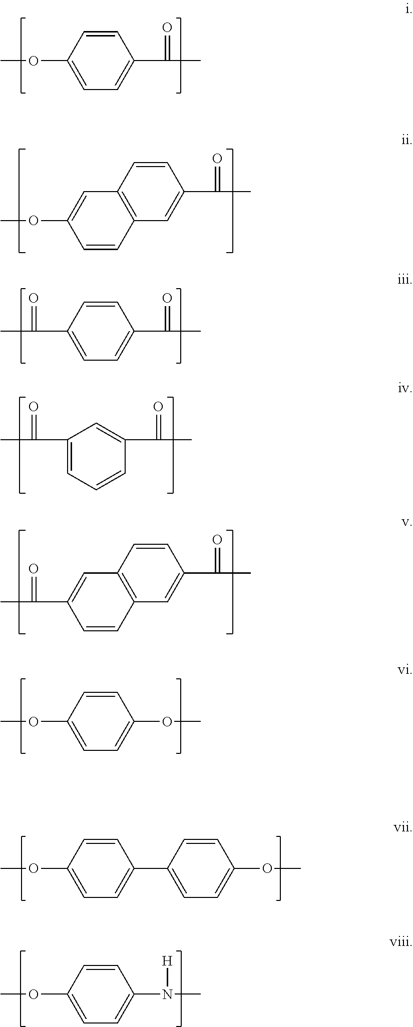

wherein the amounts of repeating units of the resin are expressed in mole % and the sum of mol % of the repeating units present always totals 100%. In certain embodiments, the resin is selected from P1 to P8 as follows:
P1 comprises from 70 to 90% i) and from 10 to 30% ii); and wherein iii)-viii) are absent;
P2 comprises from 10 to 25% i) and from 75 to 90% ii) and wherein iii)-viii) are absent;
P3 comprises from 50 to 70% ii), iii) is present, at least one of vi), vii), and viii) is present, the amount of iii)=[100−ii)]/2, and the amount of iii)=the total of at least one of vi), vii) and viii), and wherein i), iv) and v) are absent;
P4 comprises from 0 to 10% i), from 40 to 60% ii), at least one of iii), iv) and v) is present, at least one of vi) and vii) and viii) is present, wherein the total of at least one of iii), iv) and v)=[100−Σ i)+ii)]/2=the total of at least one of vi), vii) and viii);
P5 comprises from 45 to 65 i), from 1 to 10% ii), at least one of iii), iv) and v) is present, at least one of vi), vii) and viii) is present, wherein the total of at least one of iii), iv) and v)=[100−Σ i)+ii)]/2=the total of at least one of vi), vii) and viii);
P6 comprises from 40 to 70% i), from 5 to 30% v), at least one of iii) and iv) are present and the total amount of at least one of iii) and iv)=[100−i)]/2−v), at least one of vi), vii) and viii) is present and the amount of at least one of vi), vii) and viii)=Σ iii), iv) and v), and wherein ii) is absent;
P7 comprises from 30 to 80% i), at least one of vi), vii) and viii) is present, v) is present, and the amount of v)=[100−i)]/2=total of at least one of vi), vii) and viii), and wherein ii), iii) and iv) are absent.
P8 comprises from 50 to 70% i), at least one of iii) and iv) is present, at least one of vi) and vii) is present, and wherein the total of at least one of iii) and iv)=[100−i)]/2=the total of at least one of vi), vii) and viii), and wherein ii) is absent.

Aromatic polymer resins and/or monomers used to form the resins are commercially available under the trade name VECTRA marketed by Ticona, LLC. Particular grades of VECTRA polymers well suited for use in the present application, for instance, include the VECTRA Ei grades, the VECTRA A grades, and the VECTRA L grades.

The particular aromatic polyester polymer selected for use in the resin composition can vary depending upon the particular application and the characteristics of the polymer. In one embodiment, for instance, an aromatic polyester polymer is selected that has a relatively high melting point, such as a melting point greater than 280° C. The melting point of the aromatic polyester polymer, for instance, can be from about 280° C. to about 370° C., such as from about 330° C. to about 340° C. Higher melting points generally produce articles having a higher heat distortion temperature (HDT).

The amount of the aromatic polyester polymer that is present in the polymer mixture in comparison to the polyarylene sulfide polymer depends upon various factors. For instance, as described above, both polymers exhibit certain strengths and weaknesses. The polymers can be blended together in order to accentuate a particular strength or to obtain a desired combination of properties. In general, the aromatic polyester polymer and the polyarylene sulfide polymer may be present in the polymer mixture at a weight ration of from about 5:1 to about 1:5. More particularly, the weight ration can be from about 1:2 to about 1:3.

The relative amounts of the different engineering polymers, in one embodiment, can be selected so that the viscosity ratio between the polyarylene sulfide polymer and the aromatic polyester polymer at a temperature of 350° C. is from about 1:10 to about 3:1. In one embodiment, for instance, the viscosities can be selectively matched such that the viscosity ratio between the polyarylene sulfide polymer and the polyester aromatic polyester is from about 1.5:1 to about 1:1.5, By matching the viscosity as described above, the resulting mixture once heated together can form a better intimate blend between the two polymers.

In one embodiment, the aromatic polyester polymer may form domains within a matrix comprised of the polyarylene sulfide polymer. The aromatic polyester polymer domains, for instance, may have a rod-like structure. About 90% of the rod-like structures, for instance, can have a diameter of from about one micron to about ten microns and can have a length of from about five microns to about 30 microns.

In accordance with the present disclosure, in order to improve the thermal stability of the polymer mixture, the resin composition contains at least one phosphite stabilizer. The stabilizer prevents thermal degradation of the polymers during melt processing. In one embodiment, for instance, the stabilizer can be added in order to minimize mold deposits. In this manner, the resulting articles or products formed from the polymer mixture have less contamination defects, and can be produced with minimum downtime for cleanup.

In addition to minimizing mold deposits, the stabilizer can also reduce yellowing or darkening of the polymer mixture, reduce loss of strength during melt processing, and improve the processability of the mixture.

In the past, various molded parts have been made from a polyarylene sulfide polymer alone without any noticeable generation of mold deposits. Molding parts from an aromatic polyester polymer alone also does not generate significant mold deposits in many applications. When a polyarylene sulfide polymer is combined with an aromatic polyester polymer, the formation of mold deposits becomes a significant issue. For instance, after about one hour of a continuous process for injection molding, mold deposits are typically generated in amounts that can contaminate the product being made. When mold deposits occur, the process typically needs to be shut down and the molds cleaned. Compositions made according to the present disclosure, however, can avoid the above problems.

As stated above, the present disclosure is directed particularly to adding a phosphite stabilizer to an alloy polymer composition containing both a polyarylene sulfide polymer and an aromatic polyester polymer. In the past, various phosphite stabilizers have been used in conjunction with aromatic polyester polymers for long term aging. It was not known, however, that particular phosphite stabilizers can be used to reduce mold deposits in an alloy composition containing bath a polyarylene sulfide polymer and an aromatic polyester polymer.

In one embodiment, the phosphite stabilizer comprises an organic phosphite. Particular phosphites that are well suited for use in the resin composition are phosphites capable of withstanding higher temperatures, especially temperatures to which the composition is subjected to during melt processing. For example, phosphites that are particularly well suited for use in the present disclosure include monophosphites and diphosphites wherein the diphosphite has a molecular configuration that inhibits the absorption of moisture and/or has a relatively high Spiro isomer content. For instance, in one embodiment, a diphosphite may be selected that has a spiro isomer content of greater than 90%, such as greater than 95%, such as greater than 98%. Particular examples include bis(2,4-dicumylphenyl)pentaerythritol diphosphite, bis(2,4-di-t-butylphenyl)pentaerythritol diphosphite, distearyl pentaerythritol diphosphite, mixtures thereof, and the like.

The phosphite, tris(2,4-di-tert-butylphenyl) phosphite, may be represented

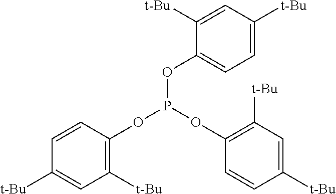 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

The phosphite, bis(2,4-dicumylphenyl)pentaerythritol diphosphite, may be represented by the formula

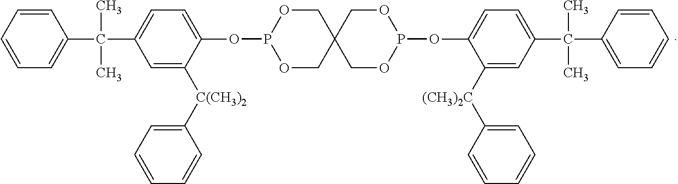

The phosphite, distearyl pentaerythritol diphosphite, may be represented by the formula

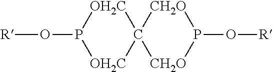

wherein R′ is an alkyl group or an aryl group and the two R′ groups may be the same or different.

In addition to a phosphite stabilizer, the resin composition can optionally contain a second stabilizer or even further stabilizers. In one embodiment, for instance, the second stabilizer may comprise a phosphate, such as an organic phosphate. For instance, in one embodiment, a non-halogen phosphate ester is incorporated into the resin composition.

Phosphates that may be used in accordance with the present disclosure include monophosphates and polyphosphates. An example of a monophosphate, for instance, is triphenyl phosphate. Polyphosphates that may be used in accordance with the present disclosure include phosphates having the following general formula:

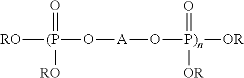

wherein r is either an unsubstituted or a substituted aryl, A is a bridging group containing an alkylene group, one arylene ring, two arylene rings either joined directly to each other or by an alkylene bridging group and n ranges from 1 to about 10. In one embodiment, A above can be a monoarylene, such as may be derived from resorcinol or hydroquinone. In the above formula, “bis” phosphates are formed when n is equal to 1. Oligomeric phosphates, on the other hand, are formed when n is equal to 2 or higher.

Various phosphates that may be used in accordance with the present disclosure are disclosed in U.S. Pat. No. 5,679,288 and in U.S. Pat. No. 6,569,928, which are both incorporated herein by reference.

Particular examples of phosphates that may be used in the present disclosure include resorcinol bis(di-xylyl phosphate), bis-phenol A bis(diphenyl phosphate), recorcinol bis(diphenyl phosphate) or mixtures thereof.

Phosphates typically exist as a liquid at room temperature or as a solid. In one embodiment a solid phosphate may be incorporated into the resin composition which may be more stable at higher temperatures and may be easier to combine with the other components.

The composition may also optionally contain an alkylene-acrylic ester interpolymer stabilizer. For instance, a random ethylene-acrylic ester interpolymer containing maleic anhydride or containing glycidyl methacrylate may be incorporated into the composition. Such compounds are commercially available from Arkema under the trade name LOTADER.

The stabilizers can be present in the resin composition in relatively small amounts. For instance, each stabilizer can be present in the composition in an amount less than about 5% by weight of the polymer mixture. For example, the phosphite stabilizer may be present in the composition in an amount from about 0.05% to about 5% by weight, such as from about 0.1% to about 1% by weight. As described above, one or more other stabilizers may also be incorporated into the composition. The other stabilizers may be present in an amount less than about 2% by weight, such as in an amount from about 0.1% to about 1% by weight.

In addition to the polymer mixture and the phosphite stabilizer, the composition can contain various other components. In one embodiment, for instance, the composition can contain one or more lubricants. Such lubricants can include, for instance, a stearate, such as pentaerythritol stearate, a polytetrafluoroethylene polymer, a high density polyethylene, or an ultra high molecular weight polyethylene. The ultra high molecular weight polyethylene, for instance, may have a molecular weight greater than about 1 million. The lubricant may be present in the resin composition in an amount less than about 5% by weight, such as from about 0.1% to about 2% by weight.

In addition to a lubricant, the resin composition can also contain a reinforcing agent, such as reinforcing fibers or mineral fillers. In one embodiment, for instance, the resin composition may contain glass reinforcing fibers. Any suitable glass fibers may be included in the composition. In one embodiment, for instance, the fibers may be comprised of lime-aluminum borosilicate glass.

Other reinforcing fibers that may be used in accordance with the present disclosure include talc fibers, wollastonite fibers, carbon fibers, metal fibers, aromatic polyamide fibers, rockwool fibers, shape memory alloy fibers, boron fibers, poly(p-phenylene-2,6-benzobisoxazole) fibers, and mixtures thereof. Carbon fibers that may be used include amorphous carbon fibers, graphitic carbon fibers, or metal-coated carbon fibers. Metal fibers may include stainless steel fibers, aluminum fibers, titanium fibers, magnesium fibers, tungsten fibers, and the like.

Fiber diameters can vary depending upon the particular fiber used. The reinforcing fibers, for instance, can have a diameter of less than about 500 microns, such as less than about 250 microns, such as less than about 100 microns. For instance, the fibers can have a fiber diameter of from about 5 microns to about 50 microns, such as from about 8 microns to about 25 microns. If desired, the fibers may be pretreated with a sizing that may also facilitate mixing with the polymer materials. Fiber lengths can vary dramatically depending upon the particular application. In one embodiment, for instance, the fibers can have an initial length of from about 3 mm to about 5 mm.

The reinforcing fibers can be present within the resulting article in an amount from about 10% to about 70% by weight, such as from about 30% to about 50% by weight.

Suitable mineral fillers that may be included in the resin composition include talc, clay, silica, calcium silicate, mica, calcium carbonate, titanium dioxide, mixtures thereof, and the like. The fillers may be present in the composition in the amount from about 0.5% to about 50% by weight, such as from about 5% to about 40% by weight.

If desired, one or more coloring and/or opacifying pigments may also be incorporated into the composition. Such agents include titanium dioxide, iron oxide, an other metallic pigments. Pigment particles can be present in the composition in an amount from about 0.1% to about 5% by weight.

The polymer alloy composition of the present disclosure can contain virgin materials or can contain reclaimed materials. For instance, in one embodiment, the alloy composition may contain re-grinded materials without appreciably reducing the properties of the resulting product. For instance, in one embodiment, the polymer alloy composition may contain from about 5% to about 50% of re-grinded polymers, such as from about 10% to about 40% of re-grinded materials.

As described above, the composition of the present disclosure is particularly well suited for use in molding processes, such as continuous injection molding processes. When used in a continuous injection molding process for more than about two hours, such as more than about four hours, such as even more than about six hours, the mold surface may exhibit little to no mold deposits. For instance, the surface area of the mold may contain mold deposits in an amount less than about 40%, such as less than about 30%, such as less than about 20%, such as less than about 10%, such as even less than about 5%.

The present disclosure may be better understood with reference to the following examples.

### Example 1

Various different polymer resin compositions were formulated and tested for thermal stability. Thermal stability was measured by measuring gloss reduction of mold surface and color reduction of molded parts.

The different resin compositions were formulated and formed into molded articles using injection molding. In particular, in order to measure gloss reduction and various tensile tests, the compositions were formed into test specimens according to ISO 3167. The multipurpose test specimen was in the shape of a tensile dog bone, >=150 mm long, with the center section 10 mm wide×4 mm thick×80 mm long. In order to test color reduction, on the other hand, the compositions were molded into the shape of a bar that was 13.5 mm long, 10 mm wide, and 0.8 mm thick.

The following tests were conducted on the samples:

### Tensile Strength, Strain and Modulus

The tensile strength and strain properties of the sample were tested according to ISO Test No. 527. Calculations of tensile strength at break, percent elongation at break, and tensile modulus were performed.

### Gloss Reduction

Gloss reduction is used to measure the deposit generation. A gloss meter is used to measure the glossiness of the mold surface first on the clean mold surface before molding and then on the mold surface after one hour of molding. Gloss reduction (%) is defined as follows:

Gloss reduction (%)=(glossiness before molding−glossiness after 1 hour of molding)/glossiness before molding×100

Glossiness readings are taken at two different locations of the mold surface with three repeat measurements at each location. The average of the readings is taken for calculating the gloss reduction. Lower gloss reduction corresponds to less deposit generated on the mold.

Any suitable gloss meter may be used to measure glossiness, such as Micro-TRI-Gloss from BYK Gardner GmbH.

### Color Reduction

Color L reduction is used to measure the thermal stability of the molded specimen. First, the color L is measured on the specimen after it is produced. Then the specimen is dipped into silicone oil at 290° C. for 2 minutes and the color L is measured again after the heat treatment. The color L reduction is calculated as follows:

Color L Reduction=Color L of molded specimen−Color L of the specimen after heat treatment at 290° C. for 2 minutes.

Less color L reduction represents higher thermal stability.

The following tables provide the compositions tested and the results obtained.

| SAMPLE NO. | 1 | 2 | 3 | 4 | 5 | 6 | 7 | 8 | 9 | 10 | 11 | 12 |
|---|---|---|---|---|---|---|---|---|---|---|---|---|
| PPS (%) (melt viscosity 45 Pa.s to | 38.7 | 38.2 | 38.2 | 38.2 | 38.2 | 38.2 | 38.2 | 38.2 | 38.2 | 38.2 | 38.2 | 38.2 |
| 65 Pa.s) | | | | | | | | | | | | |
| LCP (%) (melting point 335° C.) | 19 | 19 | 19 | 19 | 19 | 19 | 19 | 19 | 19 | 19 | 19 | 19 |
| Fiber glass (%) | 40 | 40 | 40 | 40 | 40 | 40 | 40 | 40 | 40 | 40 | 40 | 40 |
| Pentaerythritol Stearate (%) | 0.3 | 0.3 | 0.3 | 0.3 | 0.3 | 0.3 | 0.3 | 0.3 | 0.3 | 0.3 | 0.3 | 0.3 |
| PTFE (%) | 2 | 2 | 2 | 2 | 2 | 2 | 2 | 2 | 2 | 2 | 2 | 2 |
| A-1 (%) | | 0.5 | | | | | | | | | | |
| A-2 (%) | | | 0.5 | | | | | | | | | |
| A-3 (%) | | | | 0.5 | | | | | | | | |
| A-4 (%) | | | | | 0.5 | | | | | | | |
| A-5 (%) | | | | | | 0.5 | | | | | | |
| A-6 (%) | | | | | | | 0.5 | | | | | |
| A-7 (%) | | | | | | | | 0.5 | | | | |
| A-8 (%) | | | | | | | | | 0.5 | | | |
| A-9 (%) | | | | | | | | | | 0.5 | | |
| A-10 (%) | | | | | | | | | | | 0.5 | |
| A-11 (%) | | | | | | | | | | | | 0.5 |
| Total, % | 100 | 100 | 100 | 100 | 100 | 100 | 100 | 100 | 100 | 100 | 100 | 100 |
| Melt viscosity @ 350° C. and 1000 | 45.8 | 50.6 | 50.1 | 51.4 | 50.3 | 46.1 | 50.6 | 46.9 | 48.1 | 44.7 | 45.7 | 41.3 |
| s⁻¹ (Pa.s) | | | | | | | | | | | | |
| Gloss reduction (%) | 62% | 40% | 30% | 1% | 7% | 3% | 0% | 25% | 37% | 5% | 11% | 38% |
| Color L as molded | 75.0 | 77.4 | 77.3 | 81.3 | 80.1 | 81.8 | 80.3 | 78.4 | 77.8 | 79.3 | 78.8 | 79.4 |
| Color L after 290° C. for 2 min | 69.3 | 74.2 | 72.5 | 80.8 | 75.9 | 81.1 | 79.7 | 74.2 | 72.7 | 73.2 | 74.6 | 76.7 |
| Color L reduction after 290° C. for 2 | 5.7 | 3.2 | 4.8 | 0.5 | 4.2 | 0.7 | 0.6 | 4.2 | 5.1 | 6.1 | 4.2 | 2.7 |
| min | | | | | | | | | | | | |
| Tensile stress @ break (Mpa) | 136 | 134 | 140 | 125 | 101 | 119 | 132 | 138 | 143 | 142 | 136 | 129 |
| Tensile strain @ break (%) | 1.2 | 1.1 | 1.2 | 1.0 | 0.8 | 0.9 | 1.0 | 1.0 | 1.2 | 1.1 | 1.1 | 1.0 |
| Tensile Modulus (Mpa) | 16008 | 16380 | 16013 | 16488 | 15826 | 16894 | 17105 | 17322 | 16479 | 17625 | 16536 | 16574 |

A-1 is 2,2′,2″-nitrilo[triethyl-tris[3,3′,5,5′-tetra-tert-butyl-1,1′-biphenyl-2,2′-diyl]] phosphite
A-2 is Bis(2,4-di-t-butylphenol) Pentaerythritol Diphosphite
A-3 is Tris (2,4-di-tert-butylphenyl)phosphite
A-4 is Phosphorous trichloride, reaction products with 1,1′-biphenyl and 2,4-bis(1,1-dimethylethyl)phenol
A-5 is Distearyl pentaerythritol diphosphite
A-6 is Bis (2, 4-dicumylphenyl) pentaerythritol diphosphite
A-7 is Resorcinol bis(di-xylyl phosphate)
A-8 is Bis-phenol A-bis (dipenyl phophate)
A-9 is Resorcinol bis (diphenyl phosphate)
A-10 is triphenyl phophate
A-11 is Pentaerythritol Phosphate

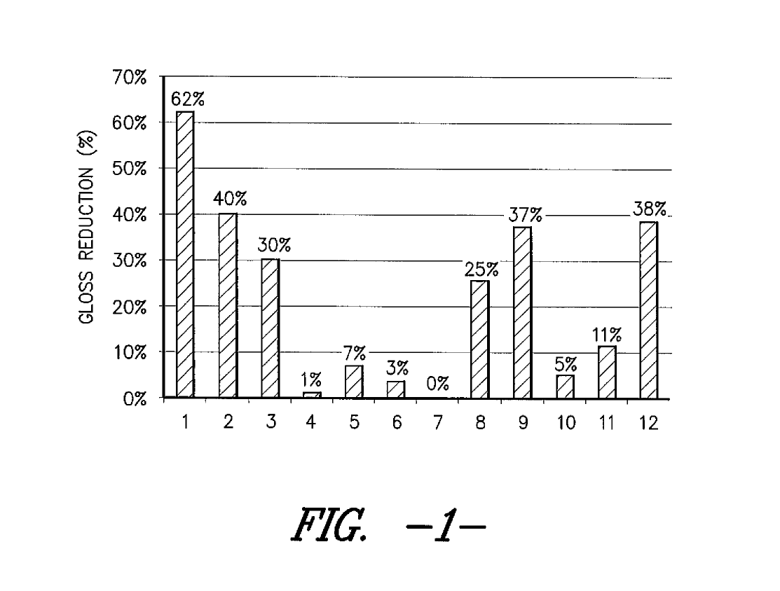

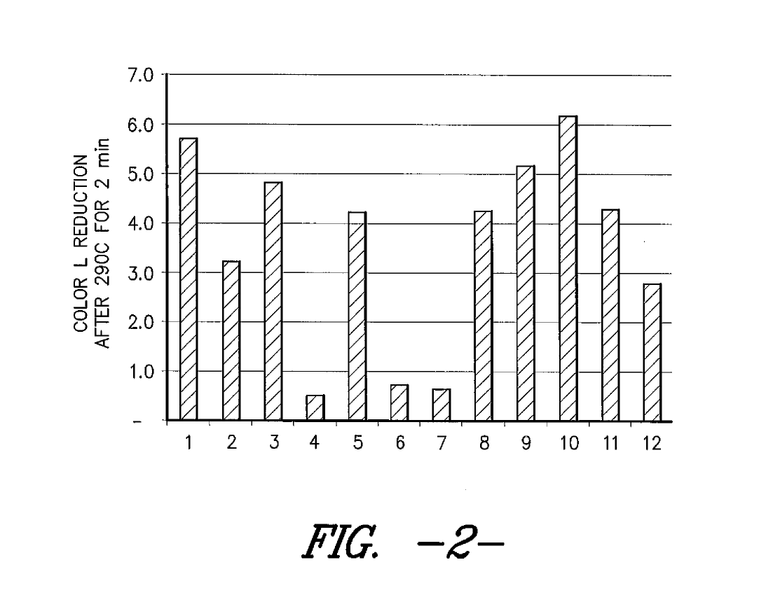

FIGS. 1 and 2 graphically illustrate the gloss reduction and the color L reduction of the samples.

As shown above, the compositions containing tris(2,4-di-tert-butylphenyl)phosphite, distearyl pentaerythritol diphosphite, or bis(2,4-dicumylphenyl)pentaerythritol diphosphite exhibited a gloss reduction of less than 10%, particularly less than 5%, and even less than 3%. The composition containing bis(2,4-dicumylphenyl)pentaerythritol diphosphite, for instance, showed no gloss reduction. The polymer compositions containing the above stabilizers also displayed a color L reduction of less than 4, particularly less than 3, and even less than 1.

### Example 2

The following example demonstrates the reduction in mold deposits when using a composition in accordance with the present disclosure.

The resin composition described above as Sample No. 6 was used in a continuous injection molding process to produce the test specimens described in Example 1. Sample No. 1, a composition that did not contain the distearyl pentaerythritol diphosphite, was also molded for purposes of comparison.

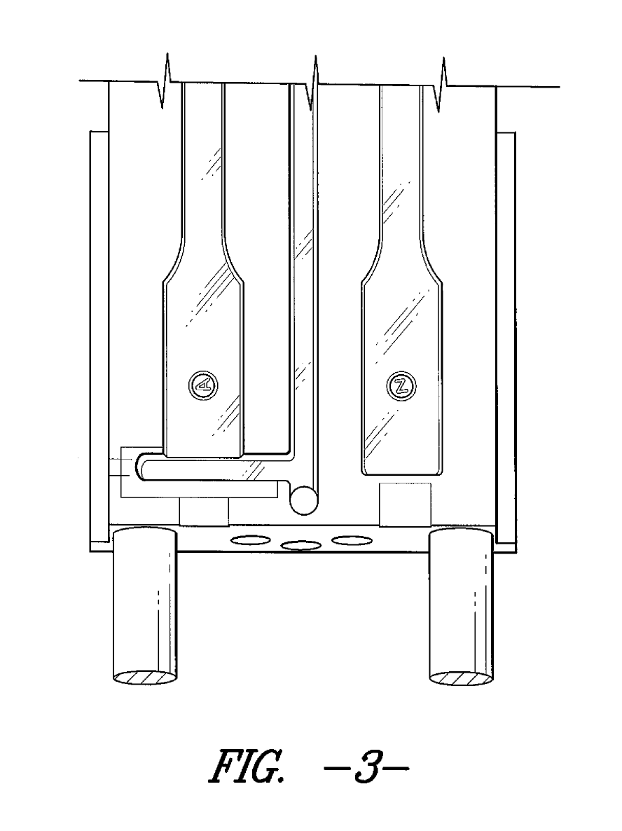

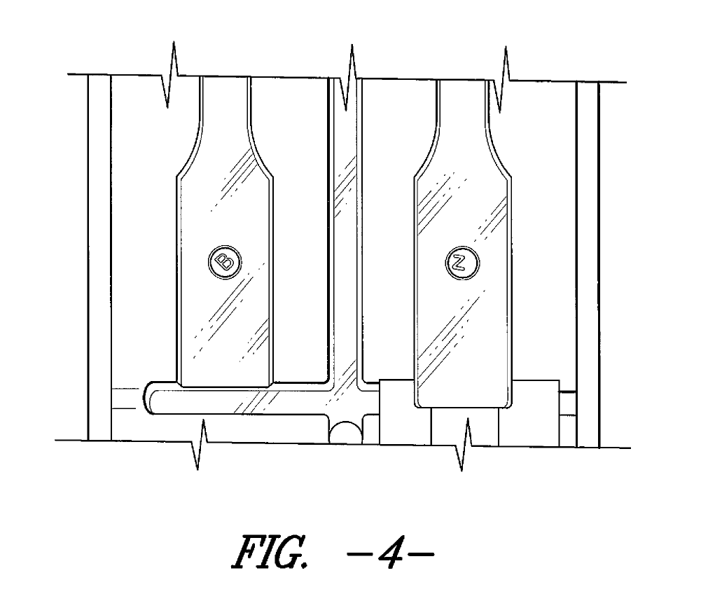

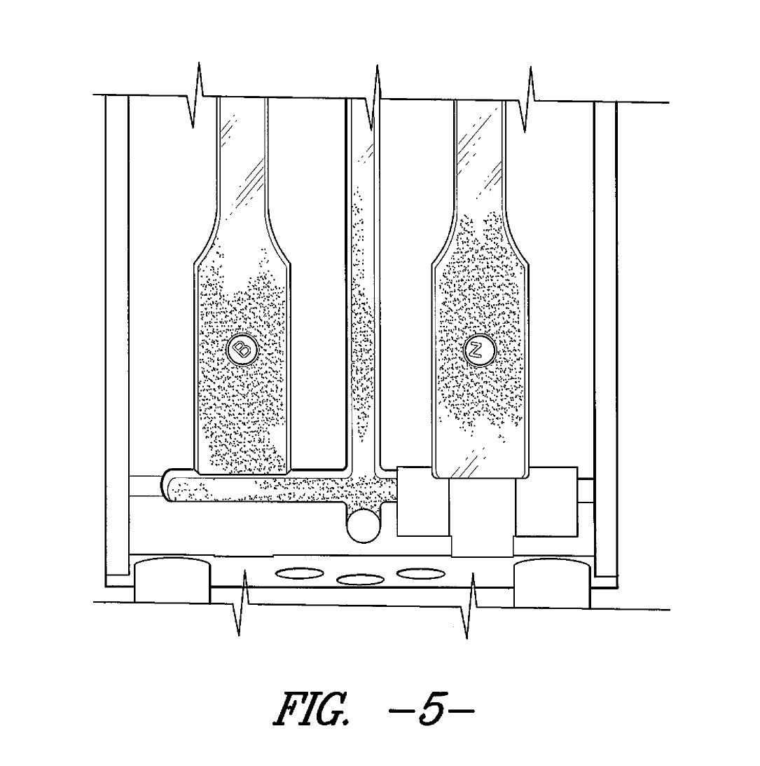

The compositions described above were used in the continuous injection molding process for four hours. After four hours, the mold surfaces were then examined and photographed. FIG. 3 illustrates the mold surface prior to molding. FIG. 4 illustrates the mold surface after four hours of continuous molding using the composition in accordance with the present disclosure (Sample No. 6 in Example 1). FIG. 5 illustrates the surface of the mold after only two hours using the composition described above not containing the phosphite stabilizer (Sample No. 1 in Example 1).

As shown in FIG. 5, the mold surface when using the composition not containing the phosphite stabilizer accumulated a considerable amount of mold deposit. The mold deposit, for instance, covers a substantial majority of the surface area of the mold.

Referring to FIG. 4, on the other hand, the mold surface after four hours of molding using a composition in accordance with the present disclosure contains substantially no mold deposits.

### Example 3

The following is a prophetic example and illustrates various other formulations that can be made in accordance with the present disclosure. It is believed that all of the following formulations would exhibit relatively low mold deposit when used to mold polymeric articles while having good color retention characteristics. In this example, instead of using glass fibers as the reinforcing filler, the compositions contain carbon fibers.

| | Sample 13 | Sampe 14 |
|---|---|---|
| | (wt. %) | (wt. %) |
| LCP Resin | 26.07 | 24.40 |
| PPS Resin | 52.13 | 48.80 |
| Polytetrafluoroethylene micropowder | 1 | 1 |
| Pentaerythritol stearate | 0.3 | 0.3 |
| Bis(2,4-dicumylphenyl) pentaerythritol | 0.5 | 0.5 |
| diphosphite | | |
| Carbon fiber | 20 | 25 |
| Total | 100.00 | 100.00 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A resin composition comprising:
a polymer mixture comprising an aromatic polyester polymer and a polyarylene sulfide polymer, the aromatic polyester polymer and the polyarylene sulfide polymer being present in the polymer mixture at a weight ratio of from about 5:1 to about 1:5; and
at least a first stabilizer comprising a phosphite, the phosphite comprising a monophosphite or a diphosphite having a Spiro isomer content of greater than 90%.

2. A composition as defined in claim 1, wherein the phosphite comprises tris(2,4-di-tert-butylphenyl) phosphite.

3. A composition as defined in claim 1, wherein the phosphite comprises bis(2,4-dicumylphenyl)pentaerythritol diphosphite.

4. A composition as defined in claim 1, wherein the phosphite comprises distearyl pentaerythritol diphosphite.

5. A composition as defined in claim 1, wherein the polyarylene sulfide polymer has a melt viscosity of less than about 80 Pa·s and wherein the aromatic polyester polymer has a melting point of from about 250° C. to about 400° C. and wherein the polyarylene sulfide polymer comprises a polyphenylene sulfide polymer, the polyphenylene sulfide polymer having a chlorine concentration that ensures the chlorine content of the composition to be less than 900 ppm.

6. A composition as defined in claim 1, further comprising a second stabilizer comprising an organic polyphosphate.

7. A composition as defined in claim 6, wherein the organic polyphosphate has the following formula: 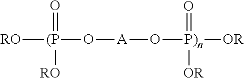
wherein r is either an unsubstituted or a substituted aryl, A is a bridging group containing an alkylene group, one arylene ring, two arylene rings either joined directly to each other or by an alkylene bridging group and n ranges from 1 to about 10.

8. A composition as defined in claim 6, wherein the organic polyphosphate comprises resorcinol bis(di-xylyl phosphate).

9. A composition as defined in claim 6, further comprising a lubricant, the lubricant comprising a polytetrafluoroethylene polymer, a high density polyethylene polymer, an ultra high molecular weight polyethylene polymer, or pentaerythritol stearate.

10. A composition as defined in claim 1, wherein the composition further comprises reinforcing fibers or mineral fillers.

11. A composition as defined in claim 1, further comprising a random ethylene-acrylic ester interpolymer containing maleic anhydride or glycidyl methacrylate.

12. An injection molded article made from the composition defined in claim 1.

13. A pellet comprising the composition defined in claim 9.

14. A composition as defined in claim 1, wherein the aromatic polyester polymer and the polyarylene sulfide polymer are present in the polymer mixture in amounts such that the polymers have a viscosity ratio at 350° C. of from about 1:10 to about 3:1.

15. A continuous injection molding process comprising:
injecting a molten polymer mixture into a mold having a surface area, the polymer mixture comprising an aromatic polyester polymer and a polyarylene sulfide polymer, the aromatic polyester polymer and the polyarylene sulfide polymer being present in the polymer mixture at a rate ratio of from about 5:1 to about 1:5, the polymer mixture further comprising a first stabilizer comprising a phosphite, the phosphite comprising a monophosphite or a diphosphite; and
wherein, after four hours of continuous molding, the surface area of the mold is covered by mold deposits in an amount of less than about 20%, the process producing molded articles, the molded articles exhibiting a gloss reduction of less than 10% and displaying a color L reduction of less than 4.
